(19) United States
(12) Patent Application Publication
(10) Pub. No.: US 2026/0358680 A1
(43) Pub. Date: Nov. 12, 2026

(54) ACTUATOR AND LENS BARREL EQUIPPED WITH SAME

(71) Applicant: Panasonic Intellectual Property Management Co., Ltd., Osaka (JP)

(72) Inventors: Yuichiro KIMOTO, Osaka (JP); Takayuki YAMAMOTO, Osaka (JP)

(73) Assignee: Panasonic Intellectual Property Management Co., Ltd., Osaka (JP)

(21) Appl. No.: 19/667,202

(22) Filed: May 4, 2026

(30) Foreign Application Priority Data
May 8, 2025 (JP) 2025-078253

(51) Int. Cl. G03B 13/34; G03B 17/14

(52) U.S. Cl. CPC G03B 13/34; G03B 17/14

(57) ABSTRACT

The linear actuator 1 includes the linear yokes 21e and 21h, the linear coil 23d, the fourth lens group unit 21, and the screws 21g and 21j. The linear yoke 21h is disposed along the optical axis AX direction at a position opposite the linear yoke 21e. The linear coil 23d is disposed at a position near the linear yokes 21e and 21h. The screws 21g, 21j fix the linear yoke 21e, 21h to the fourth lens group unit 21, etc. The screws 21g, 21j are disposed at positions where they are offset each other when viewed in the attachment direction.

### CROSS-REFERENCE TO RELATED APPLICATIONS

This application claims priority to Japanese Patent Application No. 2025-078253 filed on May 8th, 2025. The entire disclosure of Japanese Patent Application No. 2025-078253 is hereby incorporated herein by reference.

### BACKGROUND

### Technical Field

The present disclosure relates to an actuator that is mounted on a lens barrel, and to a lens barrel equipped with this actuator.

### Description Of The Related Art

Actuators that drive a lens frame mounted on a lens barrel in the optical axis direction have in recent years included a coil, a magnet, and a yoke.

When two yokes disposed opposite each other are fixed only by their mutual magnetic force, there is the risk that they may deviate from their fixed positions due to external impact or vibration.

For example, Patent Literature 1 discloses a lens barrel having an optical holding means for holding an optical element and driving the optical element so that there is a component perpendicular to the optical axis direction, a magnetic drive circuit that drives the optical holding means, and a base plate that fixes and holds the magnetic drive circuit, and also having a vibration correction device that drives the optical holding means to correct image blur, wherein the magnetic drive circuit has a first yoke, a second yoke, and a magnet, this magnet is disposed on one side of the first yoke, and the other side is coupled to the base plate, and a first support pillar that is fixed to the first yoke and extends in the optical axis direction is disposed between the second yoke and the first yoke.

### CITATION LIST

### Patent Literature

Patent Literature 1: JP-A 2009-163089

### SUMMARY

### Problem To Be Solved By The Invention

However, the following problem is encountered with the conventional lens barrel discussed above.

With the lens barrel configuration disclosed in the above publication, the fixing screws are disposed in the same phase, which makes it difficult for the product to be made more compact or thinner.

It is an object disclosed herein to provide an actuator that can be made smaller or thinner than in the past, as well as a lens barrel equipped with this actuator.

### Means For Solving Problem

The actuator according to the present disclosure drives an optical component in a specific drive direction, and includes a first yoke, a second yoke, a coil, a first fastening member, and a second fastening member. The first yoke is disposed in the drive direction. The second yoke is disposed in the drive direction at a position opposite the first yoke. The coil is disposed at a position near the first yoke and the second yoke. The first fastening member fixes the first yoke to a fixed member. The second fastening member fixes the second yoke to a fixed member. The first fastening member and the second fastening member are disposed at positions that are offset when viewed in the direction in which the first fastening member and the second fastening member are attached.

### Effects

With the actuator according to the present disclosure, a product that is smaller or thinner than conventional actuators can be obtained.

### BRIEF DESCRIPTION OF THE DRAWINGS

FIG. 1 is an overall oblique view of the state in which the lens barrel including linear actuator according to an embodiment of the present disclosure has been removably attached to a camera body;

FIG. 2 is an oblique view of the configuration of the lens barrel in FIG. 1;

FIG. 3 is an exploded oblique view of the configuration of the lens barrel in FIG. 1;

FIG. 4 is an oblique view of the configuration of a third lens group unit and a fourth-fifth lens group unit included in the lens barrel in FIG. 3;

FIG. 5 is an exploded oblique view of the configuration of the third lens group unit and the fourth-fifth lens group unit in FIG. 4;

FIG. 6 is an exploded oblique view of the configuration of main components of the linear actuator of the fourth-fifth lens group unit in FIG. 5;

FIG. 7 is an oblique view of the configuration on the image plane side of the fourth lens group unit included in FIG. 6;

FIG. 8 is an exploded oblique view of the configuration of the fifth lens group unit and a pair of linear yokes that constitute a linear actuator that drives the fifth lens group unit included in FIG. 6;

FIG. 9 is a plan view of the fourth-fifth lens group unit in FIG. 5, etc., as viewed from the image plane side;

FIG. 10 is a cross-sectional view along the G–G line in FIG. 9;

FIG. 11 is an oblique view of the configuration on the image plane side of the fourth-fifth lens group unit in FIG. 5, etc.;

FIG. 12 is a detail view of the X portion in FIG. 11;

FIG. 13 shows the attachment direction of screws used to fix the yoke in the X portion in FIG. 11;

FIG. 14 is an oblique view of the configuration of the linear actuator according to another embodiment disclosed herein;

FIG. 15 is an exploded oblique view of the configuration of the yoke, etc., included in the linear actuator in FIG. 14;

FIG. 16 is an oblique view of the configuration of an OIS unit equipped with the actuator according to yet another embodiment disclosed herein;

FIG. 17A is an exploded oblique view of the configuration of the OIS unit in FIG. 16;

FIG. 17B is a cross-sectional view of the mounting structure of the yoke included in the OIS unit in FIG. 17A;

FIG. 18 is a front view of the configuration of a BIS unit equipped with the actuator according to yet another embodiment disclosed herein;

FIG. 19A is a cross-sectional view along the D–D line in FIG. 18; and

FIG. 19B is a cross-sectional view along the E–E line in FIG. 18.

### DETAILED DESCRIPTION OF THE EMBODIMENT

Embodiments will now be described through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

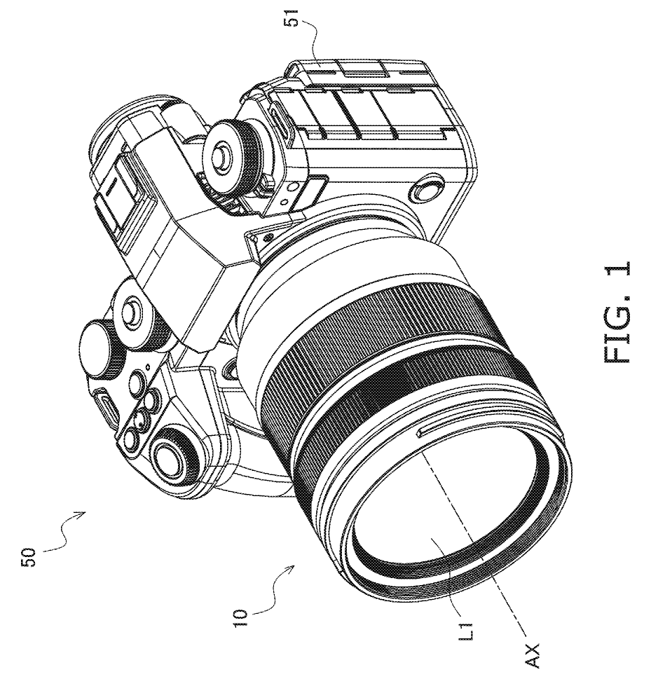

The linear actuator (actuator) 1 according to an embodiment of the present disclosure and lens barrel 10 equipped with this linear actuator 1 will now be described with reference to FIGS. 1 - 13.

### 1 Configuration of Camera 50

As shown in FIG. 1, the camera (imaging device) 50 according to this embodiment includes the lens barrel 10 and a camera body 51.

The lens barrel 10 is removably attached to the camera body 51. The detailed configuration of the lens barrel 10 will be described below.

The camera body 51 captures an image of a subject through the lens barrel 10 with an imaging element mounted inside, and thereby produces image data.

### 2 Overall Configuration of Lens Barrel 10

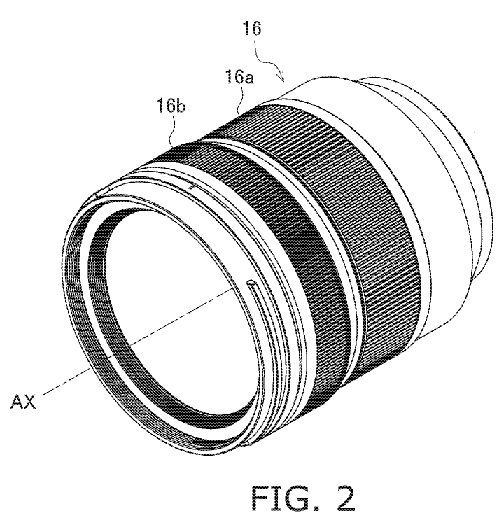

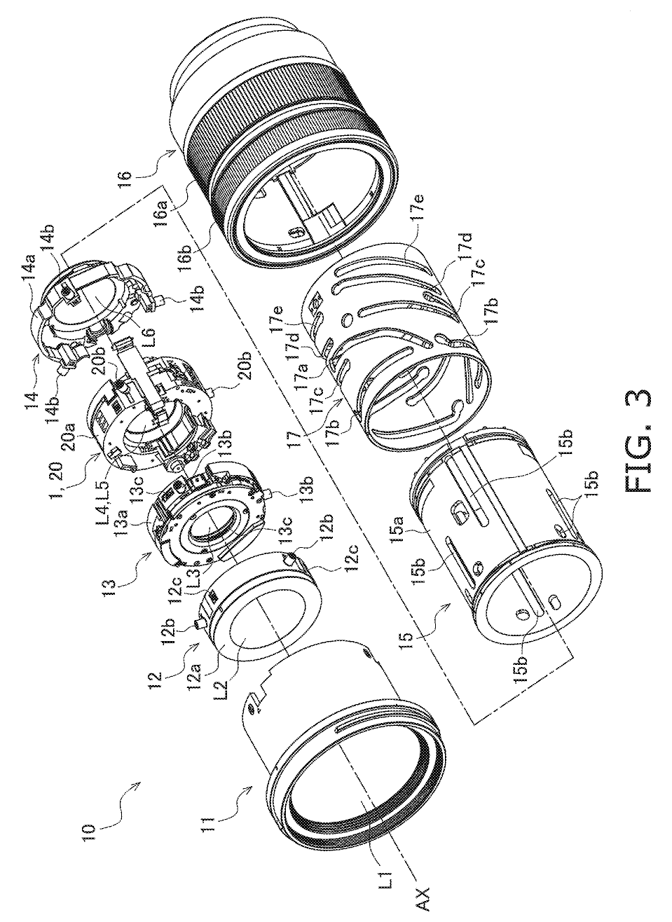

The lens barrel 10 according to this embodiment is removably attached to the camera body 51. As shown in FIGS. 2 and 3, the lens barrel 10 includes a first lens group unit 11, a second lens group unit 12, a third lens group unit 13, a fourth-fifth lens group unit 20, a sixth lens group unit 14, a rectilinear guide barrel 15, a cam barrel 17, and an exterior unit (cylindrical member) 16.

As shown in FIGS. 2 and 3, the first lens group unit 11 is a substantially cylindrical member that is disposed the closest to the subject in the optical axis AX direction out of all the components constituting the lens barrel 10, and holds a lens (first lens group) L1 on its inner peripheral surface side. The first lens group unit 11 has a cam follower (not shown) that moves in a state of being engaged with a cam groove 17a of a cam barrel 17 (discussed below), and is moved back and forth in the optical axis AX direction as the cam barrel 17 rotates relative to a rectilinear guide barrel 15.

As shown in FIG. 3, the second lens group unit (second lens frame) 12 holds a lens L2, and moves back and forth in the optical axis AX direction on the inner peripheral surface side of the rectilinear guide barrel 15 as the cam barrel 17 rotates relative to the rectilinear guide barrel 15. The second lens group unit 12 has a substantially cylindrical main body portion 12a and cam followers 12b that protrude outward in the radial direction around the optical axis AX.

Three cam followers 12b are disposed at approximately equal angular intervals (about 120 degrees) on the outer peripheral surface of the substantially cylindrical main body portion 12a. The cam followers 12b move in a state of being engaged with cam grooves 17b of the cam barrel 17 (discussed below), which moves the second lens group unit 12 back and forth in the optical axis AX direction as the cam barrel 17 rotates relative to the rectilinear guide barrel 15.

As shown in FIG. 3, the third lens group unit 13 holds a lens L3, and has a substantially cylindrical main body portion 13a, cam followers 13b, and an aperture unit 13c.

Three cam followers 13b are disposed at approximately equal angular intervals (about 120 degrees) on the outer peripheral surface of the substantially cylindrical main body portion 13a. The cam followers 13b move in a state of being engaged with cam grooves 17c of the cam barrel 17 (discussed below), which moves the third lens group unit 13 back and forth in the optical axis AX direction as the cam barrel 17 rotates relative to the rectilinear guide barrel 15.

The aperture unit 13c is disposed on the subject side of the main body portion 13a in the optical axis AX direction, and adjusts the amount of light incident from the subject side that passes through the lens barrel 10 by opening and closing aperture blades (not shown) to change the opening surface area.

The fourth-fifth lens group unit 20 is a linear focus unit that adjusts the focal length by moving a focus lens or other such lens L5 contained therein back and forth in the optical axis AX direction when, for example, a focus ring 16b rotatably attached to the outer peripheral surface of the exterior unit 16 is turned. As shown in FIG. 3, the fourth-fifth lens group unit 20 holds lenses L4 and L5, and has a substantially cylindrical main body portion 20a and cam followers 20b.

Three cam followers 20b are disposed at approximately equal angular intervals (about 120 degrees) on the outer peripheral surface of the substantially cylindrical main body portion 20a. The cam followers 20b move in a state of being engaged with the cam grooves 17d of the cam barrel 17 (discussed below), which moves the fourth-fifth lens group unit 20 back and forth in the optical axis AX direction as the cam barrel 17 rotates relative to the rectilinear guide barrel 15.

The configuration of the linear actuator 1 included in the fourth-fifth lens group unit 20 will be described in detail below.

As shown in FIG. 3, the sixth lens group unit 14 holds a lens L6, and moves back and forth in the optical axis AX direction on the inner peripheral surface side of the rectilinear guide barrel 15 as the cam barrel 17 rotates relative to the rectilinear guide barrel 15. The sixth lens group unit 14 has a substantially cylindrical main body portion 14a and cam followers 14b that protrude outward in the radial direction around the optical axis AX.

Three cam followers 14b are disposed at approximately equal angular intervals (about 120 degrees) on the outer peripheral surface of the substantially cylindrical main body portion 14a. The cam followers 14b move in a state of being engaged with the cam grooves 17e of the cam barrel 17 (discussed below), which moves the sixth lens group unit 14 back and forth in the optical axis AX direction as the cam barrel 17 rotates relative to the rectilinear guide barrel 15.

As shown in FIG. 3, the rectilinear guide barrel 15 is a substantially cylindrical member that is disposed adjacent to the inner peripheral surface side of the cam barrel 17, and the second lens group unit 12, third lens group unit 13, the fourth-fifth lens group unit 20, and the sixth lens group unit 14 are disposed on the inner peripheral surface thereof. The rectilinear guide barrel 15 has a substantially cylindrical main body portion 15a and rectilinear grooves 15b.

The rectilinear grooves 15b are through-grooves formed along the optical axis AX direction, and the cam followers 12b, 13b, and 20b provided to the second lens group unit 12, the third lens group unit 13, the fourth-fifth lens group unit 20, the sixth lens group unit 14, etc., move in a state of being engaged with these grooves.

The cam barrel 17 is, for example, a substantially cylindrical member formed from aluminum, and as shown in FIG. 3, is disposed on the outer peripheral surface side of the rectilinear guide barrel 15 and drives the second lens group unit 12, the third lens group unit 13, the fourth-fifth lens group unit 20, and the sixth lens group unit 14 back and forth in the optical axis AX direction by rotating relative to the rectilinear guide barrel 15. As shown in FIG. 3, the cam barrel 17 has a substantially cylindrical main body portion 20a and a plurality of cam grooves 17a, 17b, 17c, 17d, and 17e formed in the main body portion 20a.

The cam barrel 17 is configured such that the cam grooves 17a, 17b, 17c, 17d, and 17e are formed on a substantially cylindrical aluminum member by cutting process.

As shown in FIGS. 2 and 3, the exterior unit (cylindrical member) 16 is a substantially cylindrical member that constitutes the exterior portion of the lens barrel 10, and has a circular zoom ring 16a, a focus ring 16b, etc., attached to its outer peripheral surface so as to be rotatable in the circumferential direction.

As shown in FIGS. 2 and 3, zoom ring 16a is a substantially annular member provided near the approximate center of exterior unit 16 in the optical axis AX direction, and is turned to move lens barrel 10 from its WIDE position to its TELE position. As the zoom ring 16a rotates, the cam barrel 17 also rotates, causing first lens group unit 11, the second lens group unit 12, the third lens group unit 13, the fourth-fifth lens group unit 20, and the sixth lens group unit 14 to move back and forth in the optical axis AX direction.

As shown in FIGS. 2 and 3, the focus ring 16b is a substantially annular member provided on the outer peripheral surface of the exterior unit 16 at a position adjacent to the subject side of the zoom ring 16a in the optical axis AX direction, and varies the position of the focus lens (lens L5) in the optical axis AX direction. As the focus ring 16b is turned, the fourth-fifth lens group unit 20 moves back and forth in the optical axis AX direction.

### 3 Configuration of Fourth-Fifth Lens Group Unit 20

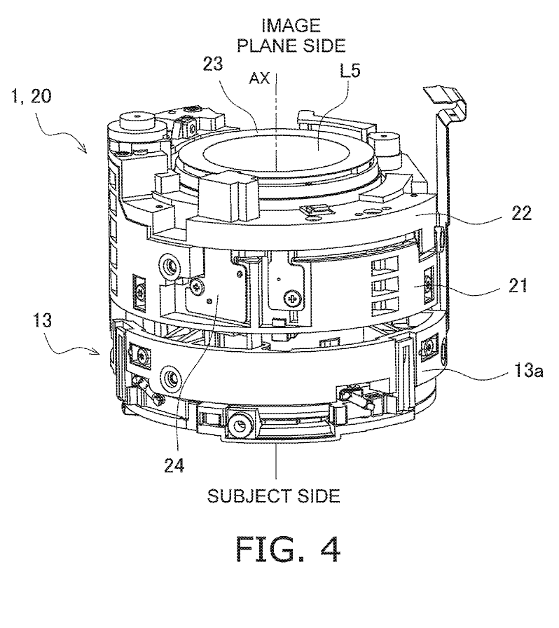

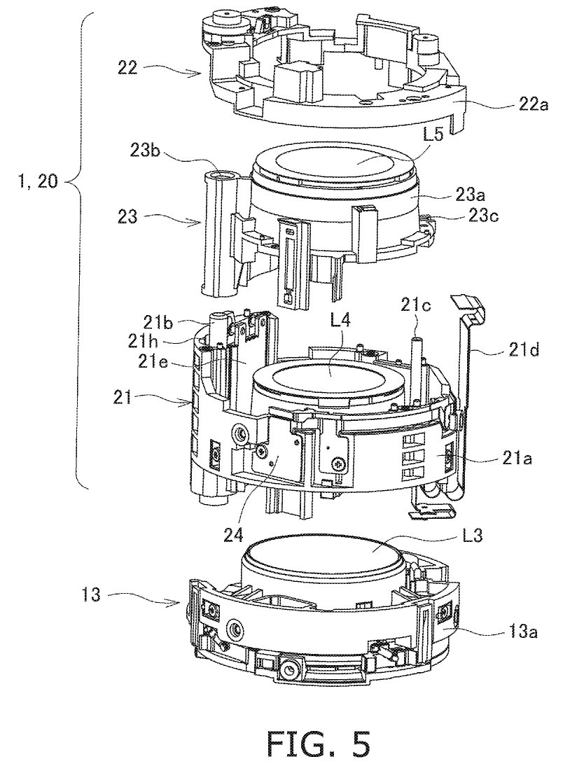

As shown in FIG. 4 and 5, with the lens barrel 10 according to this embodiment, the fourth-fifth lens group unit 20, which is disposed on the inner peripheral surface side of the rectilinear guide barrel 15 and the cam barrel 17, is moved back and forth in the optical axis AX direction. At this point, the relative positions of the fourth lens group unit 21 and the fifth lens group unit 23 included in the fourth-fifth lens group unit 20 are detected using the optical position detection unit 24 shown in FIG. 4.

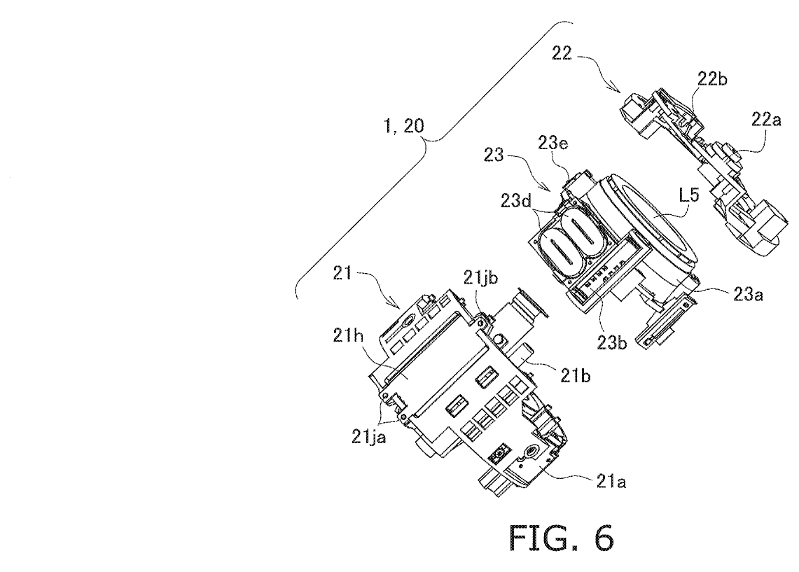

As shown in FIGS. 4 and 5, the fourth-fifth lens group unit 20 is disposed on the image plane side of the third lens group unit 13, which is disposed on the subject side in the optical axis AX direction. As shown in FIG. 6, the fourth-fifth lens group unit 20 includes a fourth lens group unit 21, an outer frame 22, and a fifth lens group unit 23.

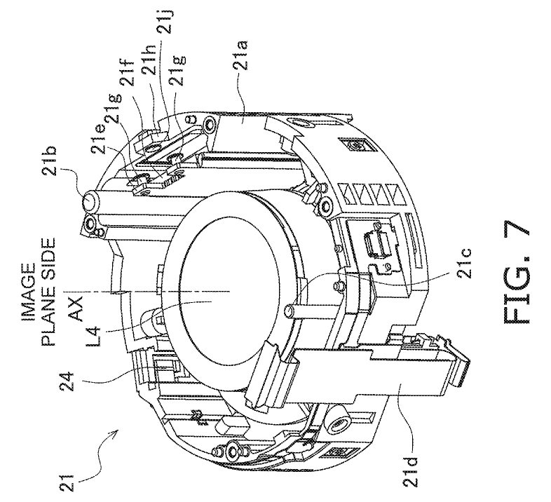

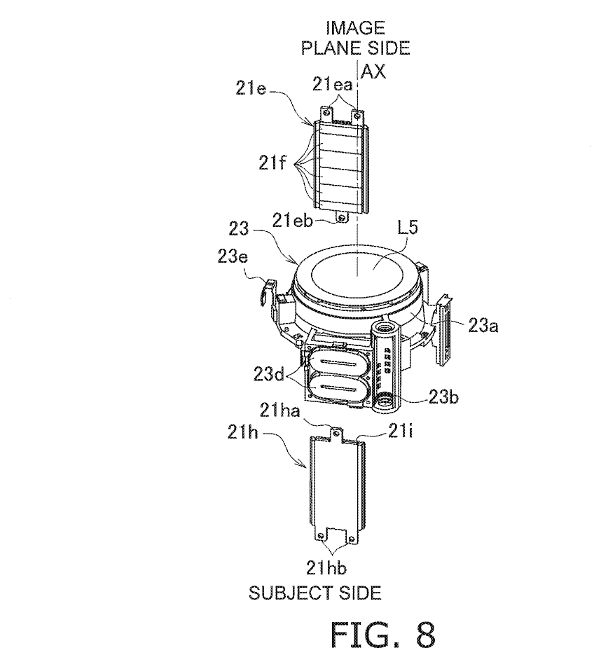

As shown in FIGS. 7 and 8, the fourth lens group unit 21 has a substantially cylindrical main body portion (fixed member) 21a, a main shaft 21b, a sub-shaft 21c, a flexible printed circuit 21d, linear yokes 21e and 21h, linear magnets 21f and 21i, screws (first fastening members) 21g, and a screw (second fastening member) 21j.

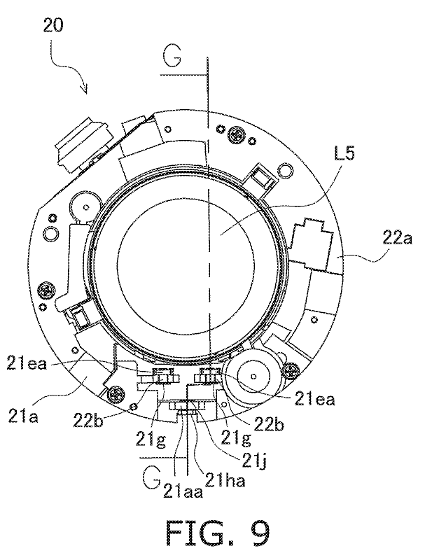

The main body portion (fixed member) 21a has a substantially cylindrical shape and holds a lens L4 at its center. The main body portion 21a also has a fixing portion 21aa to which the linear yokes 21e and 21h are fixed, as shown in FIG. 9.

The main shaft 21b and the sub-shaft 21c are disposed in the main body portion 21a along the optical axis AX direction, the main shaft 21b is inserted into the guide hole 23b of the fifth lens group unit 23, and the sub-shaft 21c is inserted into the guide hole 23c.

As a result, the fifth lens group unit 23 is guided in the optical axis AX direction by main shaft 21b and sub shaft 21c, and moves relative to the fourth lens group unit 21.

The flexible printed circuit 21d is connected to the position detection unit 24 and supplies power to the light emitting unit and the light receiving unit included in the position detection unit 24.

As shown in FIG. 7, the linear yokes 21e and 21h are attached to the outer and inner peripheral surfaces of the substantially cylindrical main body 21a. As shown in FIG. 8, the linear yokes 21e and 21h are disposed in contact with the outer and inner diameter surfaces of the linear magnets 21f and 21i, respectively.

The linear yoke (first yoke) 21e is disposed so that its lengthwise direction runs along the optical axis AX. As shown in FIG. 8, the linear yoke 21e has two holes (first holes) 21ea provided at the end portion on the image plane side in the optical axis AX direction, and one hole (first hole) 21eb provided at the end portion on the subject side.

The holes (first holes) 21ea, 21ea are provided at portions that protrude toward the image plane in the optical axis AX direction from the vicinity of the two ends in the width direction of the linear yoke 21e. The holes 21ea, 21ea are fixed to the fixing portion 22b of the outer frame 22 by threading the threaded portions of the screws 21g into the holes 21ea, 21ea.

The holes (first holes) 21eb are provided at the portion that protrudes toward the subject in the optical axis AX direction from near the center in the width direction of the linear yoke 21e. The hole 21eb is fixed to a fixing portion (not shown) of the fourth lens group unit 21 by threading the threaded portion of the screw 21g into h, 21eaole 21eb.

The linear yoke (second yoke) 21h is disposed at a position opposite the linear yoke 21e so that the lengthwise direction runs along the optical axis AX direction. As shown in FIG. 8, the linear yoke 21h has one hole (second hole) 21ha provided at the end on the image plane side in the optical axis AX direction, and two holes (second holes) 21hb provided at the end on the subject side.

The hole (second hole) 21ha is provided at the portion that protrudes toward the image plane side in the optical axis AX direction from near the center in the width direction of the linear yoke 21h. The hole 21ha is fixed to the fixing portion 21aa of the fourth lens group unit 21 by threading the threaded portion of the screw 21j into the hole 21ha.

The holes (second holes) 21hb, 21hb are provided at the portions that protrude toward the subject in the optical axis AX direction from near the center in the width direction of the linear yoke 21h. The holes 21hb, 21hb are fixed to a fixing portion (not shown) of the fourth lens group unit 21 by threading the threaded portions of the screws 21j into the holes 21hb, 21hb.

The attachment structure of the linear yokes 21e and 21h will be described in detail below.

As shown in FIG. 8, the linear magnets 21f and 21i are disposed at opposing positions so as to sandwich the linear coil 23d provided to the movable-side fifth lens group unit 23 in the radial direction.

As shown in FIG. 8, the linear magnet 21f is attached to the radially outer side of the linear yoke 21e provided on the radially inner side.

As shown in FIG. 8, the linear magnet 21i is attached to the radially inner side of the linear yoke 21h provided on the radially outer side.

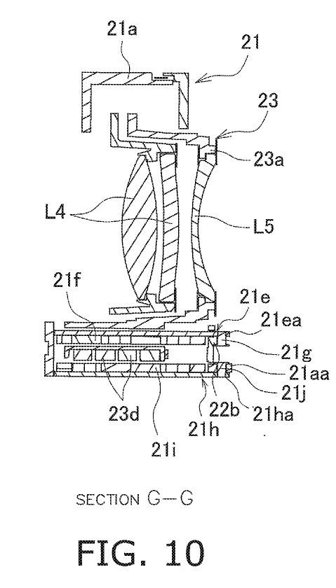

As shown in FIGS. 9 and 10, the screws (first fastening members) 21g are attached from the radially outer side (the side opposite the linear yoke 21h) of the linear yoke 21e disposed on the radially inner side, and fixes the linear yoke 21e by sandwiching the fixing portion 22b of the outer frame 22.

The same applies to the screws 21g that fix the subject side of the linear yoke 21e.

As shown in FIGS. 9 and 10, the screw (second fastening member) 21j is attached from the radially inner side (the side opposite the linear yoke 21e) of the linear yoke 21h disposed on the radially outer side, and fixes the linear yoke 21h by sandwiching the fixing portion 21aa of the fourth lens group unit 21.

The same applies to the two screws 21j that fix the subject side of the linear yoke 21h.

The outer frame 22 is fixed relatively to the fourth lens group unit 21, and has a substantially disk-shaped main body portion (fixed member) 22a and a fixing portion 22b.

As shown in FIG. 6, the main body portion 22a is a substantially disk-shaped member disposed the closest to the image plane out of the fourth-fifth lens group unit 20, and has a fixing portion 22b to which is attached a screw 21j for fixing the above-mentioned linear yoke 21h.

As shown in FIGS. 6 and 10, the fixing portion 22b is a protruding portion provided on the upper surface of the main body portion 22a, and is fixed by inserting the screws 21g for fixing the linear yoke 21e.

As shown in FIG. 6, the fifth lens group unit 23 holds a lens (optical component) L5 and is provided in a state of being able to move in the optical axis AX direction of the lens L5 on the inner peripheral surface side of the fourth lens group unit 21. As shown in FIG. 8, the fifth lens group unit 23 has a main body portion 23a, guide holes 23b and 23c, a linear coil 23d, and a linear flexible printed circuit 23e.

As shown in FIG. 8, the main body portion 23a is a substantially cylindrical member, and has the linear coil 23d, etc., disposed on its outer peripheral surface side.

The guide holes 23b and 23c are through-holes provided to the main body portion 23a in the optical axis AX direction, and the above-mentioned main shaft 21b and the sub-shaft 21c are inserted into the guide holes 23b and 23c, respectively.

As shown in FIG. 8, the linear coil 23d is disposed between linear yokes 21e and 21h on the outer peripheral surface of substantially cylindrical main body portion 23a, and at a position opposite linear yokes 21e and 21h. When the linear coil 23d is energized, an electromagnetic force is generated between linear yokes 21e and 21h disposed at the opposing positions, and this moves the fifth lens group unit 23 back and forth in the optical axis AX direction.

The linear flexible printed circuit 23e is provided on the outer peripheral surface of the main body portion 23a, is connected to the linear coil 23d, and supplies power to the linear coil 23d.

Mounting Structure of Linear Yokes 21e and 21h

With the lens barrel 10 of this embodiment, as described above, the linear yokes 21e and 21h included in the linear actuator 1 are fixed to the fixing portion 21aa of the fourth lens group unit 21 and the fixing portion 22b of the outer frame 22 with the screws 21g and 21j.

As shown in FIG. 8, the linear yoke 21e provided on the radially inner side has two holes 21ea, 21ea at the end on the image plane side in the optical axis AX direction and one hole 21eb on the subject side.

Meanwhile, the linear yoke 21h provided on the radially outer side has one hole 21ha at the end on the image plane side in the optical axis AX direction and two holes 21hb on the subject side, as shown in FIG. 8.

Here, the linear yoke 21e provided on the radially inner side and the linear yoke 21h provided on the radially outer side are attached so that their fixing positions (the positions of the holes 21ea and 21ha into which the screws 21g and 21j are inserted) do not overlap when viewed in the radial direction.

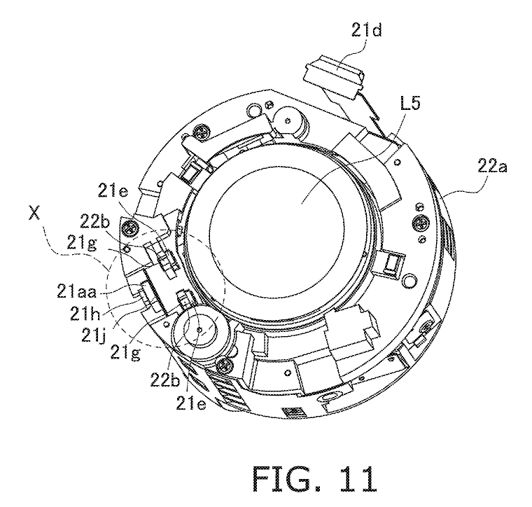

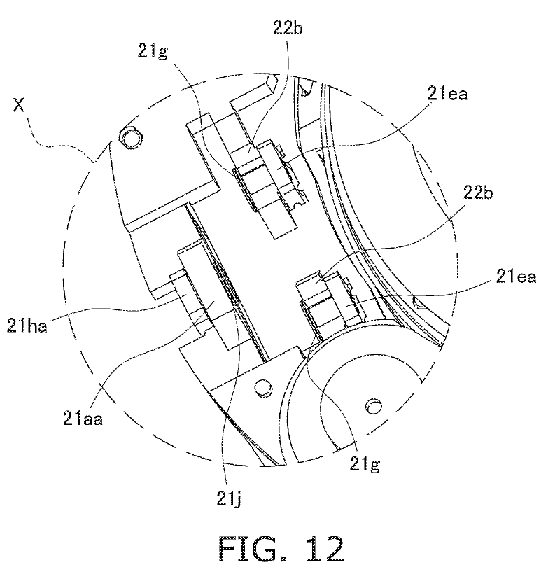

That is, the linear yoke 21e provided on the radially inner side and the linear yoke 21h provided on the radially outer side are fixed with the screws 21g and 21j at positions offset in the circumferential direction, as shown in FIGS. 11 and 12.

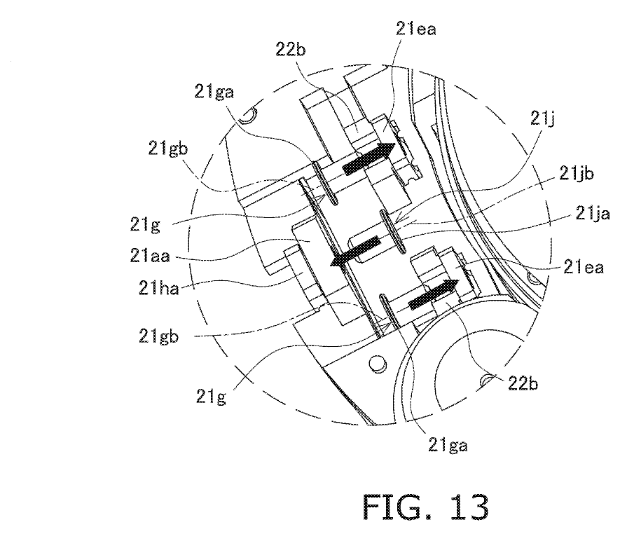

As shown in FIG. 13, the screws 21g and 21j have heads 21ga and 21ja that are turned with a tool, and rotational axes 21gb and 21jb. The screws 21g and 21j rotate around the rotational axes 21gb and 21jb and thread into the holes 21ea and 21eb of the linear yoke 21e and holes 21ha and 21hb of the linear yoke 21h, respectively.

The heads 21ga and 21ja of the screws 21g and 21j are disposed between the linear yokes 21e and 21h.

That is, as shown in FIG. 13, the screws 21g are attached from the radially outer side when fixing the linear yoke 21e provided on the radially inner side (see the arrows in the drawing).

Meanwhile, as shown in FIG. 13, the screw 21j is attached from the radially inner side when fixing the linear yoke 21h provided on the radially outer side (see the arrow in the drawing).

Consequently, the heads 21ga and 21ja of the screws 21g and 21j are positioned between the two linear yokes 21e and 21h disposed opposite each other, and this prevents the heads 21ga and 21ja from jutting out and increasing the radial size.

### Main Features

The linear actuator 1 in this embodiment drives the lens L5 in the optical axis AX direction and includes the linear yokes 21e and 21h, the linear coil 23d, the fourth lens group unit 21, the outer frame 22, and the screws 21g and 21j. The linear yoke 21e is disposed along the optical axis AX direction. The linear yoke 21h is disposed along the optical axis AX direction at a position opposite the linear yoke 21e. The linear coil 23d is disposed at a position near the linear yokes 21e and 21h. The linear yokes 21e and 21h are fixed to the main body portion 21a of the fourth lens group unit 21 and the main body portion 22a of the outer frame 22. The screws 21g fix the linear yoke 21e to the main body portion 21a of the fourth lens group unit 21, etc. The screw 21j fixes the linear yoke 21h to the main body portion 21a of the fourth lens group unit 21, etc. The screws 21g and the screw 21j are disposed at positions where they do not overlap each other when viewed in the attachment direction.

Consequently, the screws 21g and 21j can be easily turned with a tool from the inner or outer peripheral side when fixing the two opposing linear yokes 21e and 21h with the screws 21g and 21j to prevent the linear yokes 21e and 21h from coming loose due to vibration or impact. This also affords a device that is more compact and thinner than in the past.

Also, the above configuration increases the rigidity of the unit as a whole, and this suppresses vibration (improves performance).

### Other Embodiments

An embodiment of the present disclosure disclosed herein was described above, but the present disclosure is not limited to or by the above embodiment, and various modifications are possible without departing from the gist of the disclosure.

### A

In the above embodiment, an example was given in which two holes 21ea are provided on the image plane side in the optical axis AX direction of the linear yoke 21e and one hole 21eb is provided on the subject side so that the fixing positions did not overlap in the installation direction of the screws 21g and 21j, and one hole 21ha is provided on the image plane side in the optical axis AX direction of the linear yoke 21h and twenty-one holes 21hb are provided on the subject side. However, the present disclosure is not limited to this.

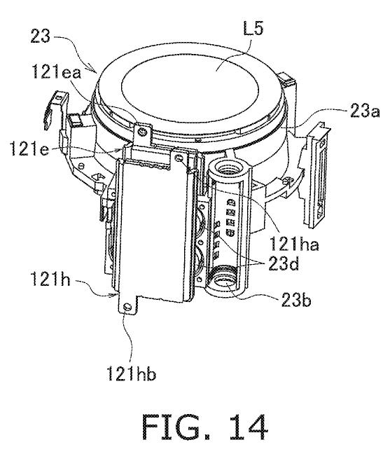

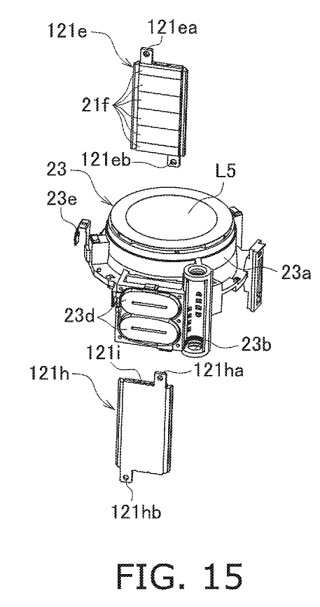

For example, in order to prevent the fixing positions from overlapping in the installation direction of the screws 21g and 21j, as shown in FIGS. 14 and 15, one hole (first hole) 121ea and 121eb and one hole (second hole) 121ha and 121hb may be provided at each of the left and right ends in the width direction at both ends in the optical axis AX direction of the linear yokes (first yoke and second yoke) 121e and121h.

Here again, the attachment positions of the linear yokes 121e and 121h are offset in the circumferential direction, making it easier to assemble the linear actuator, just as in the above embodiment.

### B

In the above embodiment, an example was given in which the configuration disclosed herein was applied to a linear actuator that drove a lens drive frame in the optical axis direction. However, the present disclosure is not limited to this.

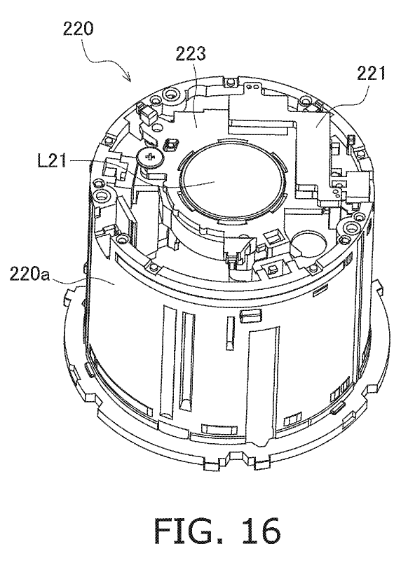

For example, as shown in FIG. 16, the configuration disclosed herein may be applied to an optical image stabilizer (OIS) unit 220 that drives a lens drive frame in a plane perpendicular to the optical axis direction.

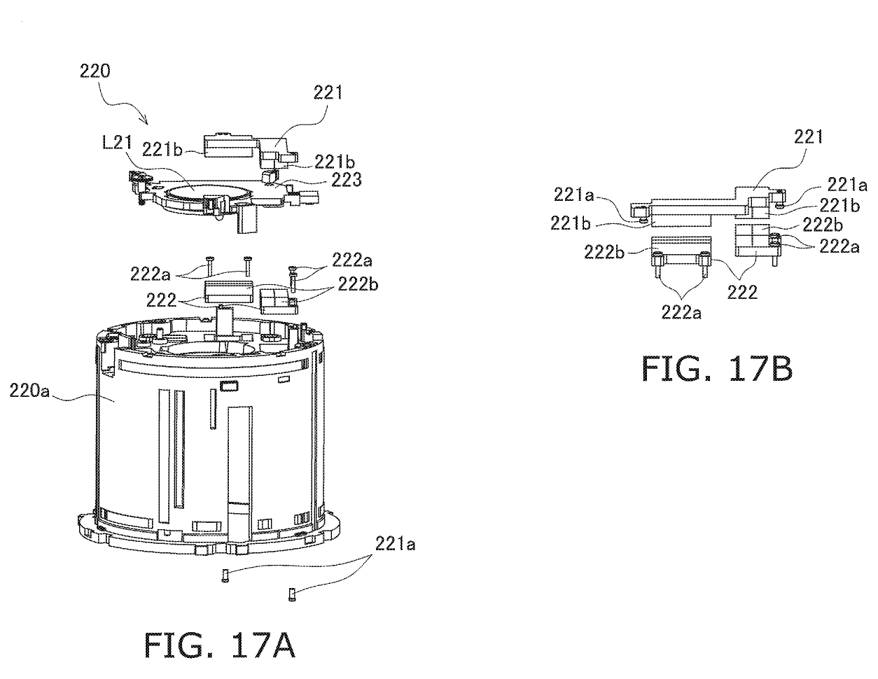

More specifically, the OIS unit 220 is a unit that moves a lens frame 223 holding a lens L21 in a plane perpendicular to the optical axis AX direction in accordance with the direction of detected vibration or impact, and as shown in FIGS. 17A and 17B, this unit includes a lens frame 223, yokes 221 and 222 disposed on either side of the lens frame 223 in the optical axis AX direction, magnets 221b and 222b disposed so as to be in contact with the inside of the yokes 221 and 222, and screws 221a and 222a.

A coil (not shown) is attached to the lens frame 223 and is disposed in close proximity between the yokes 221 and 222.

As shown in FIG. 17A, the yoke 221 is fixed with screws 221a from the surface side opposite the yoke 222 in the optical axis direction.

As shown in FIG. 17A, the yoke 222 is fixed to the upper surface of a cylindrical member (fixed member) 220a using screws 222a from the side opposite the yoke 221 in the optical axis direction.

At this point, the fixing positions of the yoke 221 and the yoke 222 are disposed so as not to overlap when viewed from the installation direction of the screws 221a and 222a, as shown in FIG. 17B.

Consequently, the OIS unit 220 is easier to assemble, among other effects, just as with the configuration described in the above embodiment.

### C

In the above embodiment, an example was given in which the configuration disclosed herein was applied to a linear actuator that drove a lens drive frame in the optical axis direction. However, the present disclosure is not limited to this.

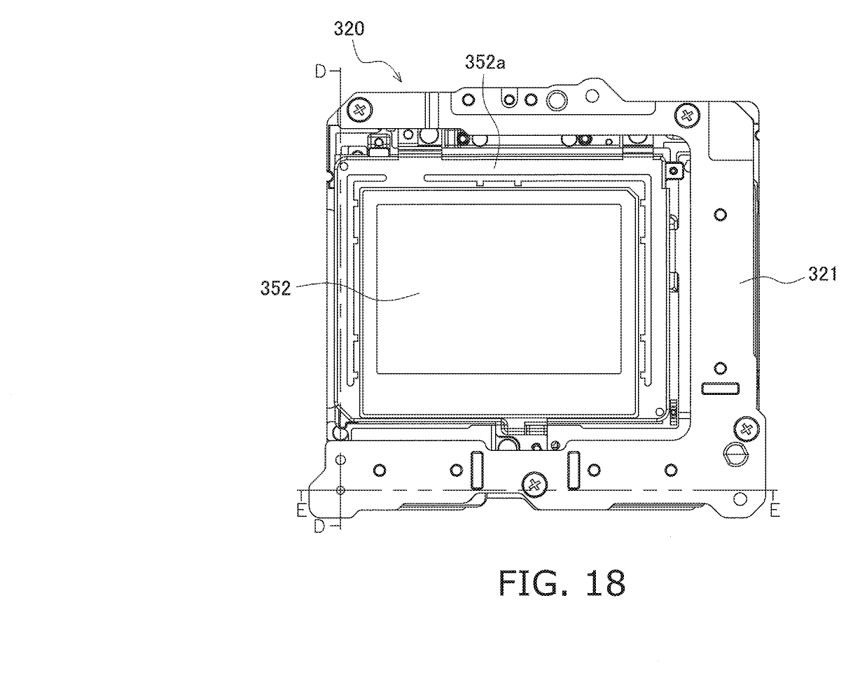

For example, as shown in FIG. 18, the configuration disclosed herein may be applied to a sensor shift type of image stabilization mechanism (BIS (in-body image stabilizer) unit) 320 that drives an image sensor (optical component) 352 in a plane perpendicular to the optical axis inside a camera body equipped with an image sensor 352.

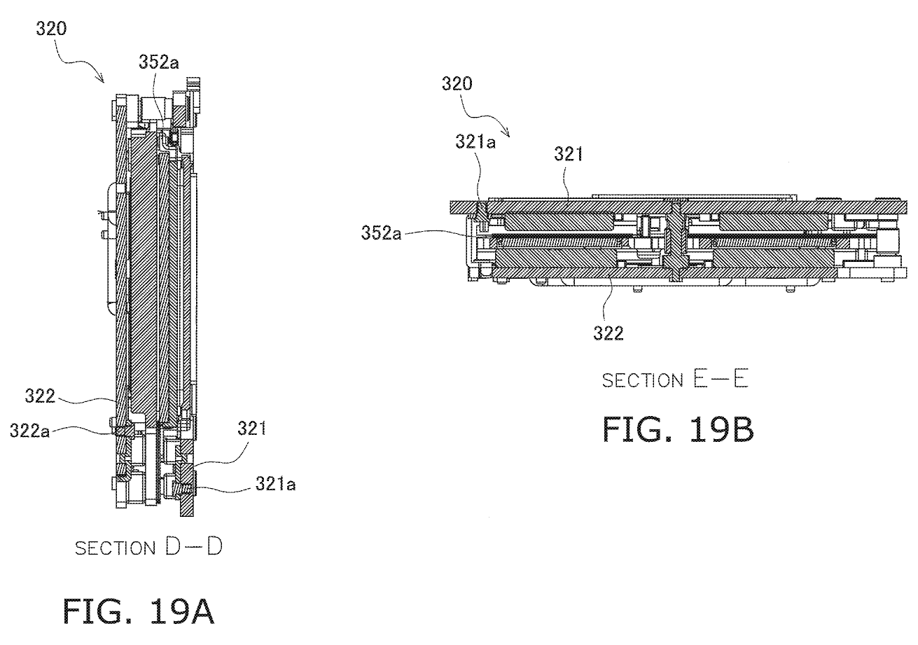

More specifically, the BIS unit 320 is a unit that moves a holding frame 352a, inside of which an image sensor 352 inside the camera body is disposed, within a plane perpendicular to the optical axis AX direction in accordance with the direction of the detected vibration or impact, and is equipped with yokes 321 and 322 as shown in FIGS. 19A and 19B.

A coil (not shown) is attached to the holding frame 352a and is disposed in close proximity between the yokes 321 and 322.

As shown in FIG. 19B, the yoke 321 is fixed with a screw 321a from the surface side opposite the yoke 322 in the optical axis direction.

As shown in FIG. 19A, the yoke 322 is fixed with a screw 322a from the side opposite the yoke 321 in the optical axis direction.

At this point, the fixing position of the yoke 321 and the fixing position of the yoke 322 are disposed so as not to overlap when viewed in the installation direction of the screws 321a and 322a, as shown in FIGS. 19A and 19B.

This has the same effect as the configuration described in the above embodiment, that is, an improvement in ease of assembly of the BIS unit 320, etc.

### D

In the above embodiment, an example was given in which the moving coil type of linear actuator 1 had the linear coil 23d provided to the movable fifth lens group unit 23. However, the present disclosure is not limited to this.

For example, a moving magnet type of actuator in which a magnet and a yoke are provided to a movable frame may be used instead.

### E

In the above embodiment, an example was given in which the main body portion 21a of the fourth lens group unit 21 and the main body portion 22a of the outer frame 22 were used as the fixed members disclosed herein. However, the present disclosure is not limited to this.

For example, the fixed member disclosed herein may be a configuration in which some other lens frame is used instead.

### F

In the above embodiment, an example was given in which the end on the image plane side of the linear yoke 21e provided on the radially inner side was fixed to the fixing portion 22b provided to the outer frame 22, rather than to the fourth lens group unit 21. However, the present disclosure is not limited to this.

For example, the configuration may be such that the first yoke provided on the radially inner side and the second yoke provided on the radially outer side are fixed to the same fixed member.

### G

In the above embodiment, an example was given in which the screws 21g and 21j were used as the first and second fastening members that fixed the linear yokes 21e and 21h, respectively. However, the present disclosure is not limited to this.

For example, rather than screws, some other kind of fastening member, such as a combination of nuts and bolts, or a clamp-type fastening member, may be used to fasten the first and second yokes.

### H

In the above embodiment, an example was given in which the configuration of the present disclosure was applied to the lens barrel 10 that is removably attached to the camera body 51. However, the present disclosure is not limited to this.

For example, the configuration of the present disclosure may be applied to a lens barrel that is fixed in an undetachable state to a camera body.

The above description of the embodiments discloses the following techniques.

### Technique 1

The actuator according to Technique 1 is:
an actuator for driving an optical component in a specific drive direction, the actuator comprising:
   a first yoke that is disposed in the drive direction;
   a second yoke that is disposed in the drive direction at a position opposite the first yoke;
   a coil that is disposed at a position near the first yoke and the second yoke;
   a first fastening member that fixes the first yoke to a member to be fixed; and
   a second fastening member that fixes the second yoke to a fixed member to be fixed;
wherein the first fastening member and the second fastening member are disposed at positions that are offset as viewed in the attachment direction of the first fastening member and the second fastening member.

### Technique 2

The actuator according to the Technique 2 is the actuator according to the Technique 1,
wherein the first fastening member fixes the first yoke from a surface side of the first yoke that is opposite the second yoke, and
the second fastening member fixes the second yoke from a surface side of the second yoke that is opposite the first yoke.

### Technique 3

The actuator according to the Technique 3 is the actuator according to the Technique 1 or 2,
the first yoke has a first hole into which the first fastening member is inserted,
The second yoke has a second hole into which the second fastening member is inserted.

### Technique 4

The actuator according to Technique 4 is the actuator according to Technique 3,
wherein the first hole is provided at one location at a first end in the lengthwise direction of the first yoke and at two locations at a second end on the opposite side from the first end, and
the second hole is provided at two locations at a first end in the lengthwise direction of the second yoke and at one location at a second end on the opposite side from the first end.

### Technique 5

The actuator according to the Technique 5 is the actuator according to Technique 3 or 4,
wherein the first fastening member and the second fastening member have a head and a rotation shaft that are rotated by a tool, and rotate around the rotation shaft to screw into the first hole of the first yoke and the second hole of the second yoke, respectively.

### Technique 6

The actuator according to Technique 6 is the actuator according to any of Techniques 1 to 5,
wherein the heads of the first fastening member and the second fastening member are disposed between the first yoke and the second yoke.

### Technique 7

The actuator according to Technique 7 is the actuator according to any of Techniques 1 to 6,
wherein the first yoke and the second yoke are disposed along the optical axis direction of the optical component.

### Technique 8

The actuator according to Technique 8 is the actuator according to Technique 7,
wherein the first fastening member and the second fastening member are disposed at positions that are offset in the circumferential direction centered on the optical axis of the optical component.

### Technique 9

The actuator according to Technique 9 is the actuator according to any of Techniques 1 to 8,
wherein the first yoke is disposed to the inside of the second yoke in the radial direction centered on the optical axis of the optical component,
the first fastening member fixes the first yoke from the outside in the radial direction, and
the second fastening member fixes the second yoke from the inside in the radial direction.

### Technique 10

The actuator according to Technique 10 is the actuator according to any of Techniques 1 to 9,
wherein the optical component includes a lens or an imaging element.

### Technique 11

The lens barrel according to Technique 11 comprises:
the actuator according to any of Techniques 1 to 10; and
a substantially cylindrical member that envelops the actuator.

### INDUSTRIAL APPLICABILITY

The actuator disclosed herein has the effect that the size and thickness can be reduced as compared to a conventional actuator, and is therefore widely applicable as an actuator that is installed in various kinds of imaging device and the like.

### REFERENCE SIGNS LIST

1 linear actuator (actuator)

10 lens barrel

11 first lens group unit

12 second lens group unit

12a main body portion

12b cam follower

13 third lens group unit

13a main body portion

13b cam follower

13c aperture unit

14 sixth lens group unit

14a main body portion

14b cam follower

15 rectilinear guide tube

15a main body portion

15b rectilinear groove

16 exterior unit (cylindrical member)

16a zoom ring

16b focus ring

17 cam barrel

17a to 17e cam grooves

20 fourth-fifth lens group unit

20a main body portion

20b cam follower

21 fourth lens group unit

21a main body portion (fixed member)

21aa fixing part

21b main shaft

21c sub-shaft

21d flexible printed circuit

21e linear yoke (first yoke)

21ea hole (first hole)

21eb hole (first hole)

21f linear magnet

21g screw (first fastening member)

21ga head

21gb rotation axis

21h linear yoke (second yoke)

21ha hole (second hole)

21hb hole (second hole)

21i linear magnet

21j screw (second fastening member)

21ja head

21jb rotation axis

22 outer frame

22a main body portion (fixed member)

22b fixing part

23 fifth lens group unit

23a main body portion

23b guide hole

23c guide hole

23d linear coil

23e linear flexible printed circuit

24 position detection unit

50 camera (imaging device)

51 camera body

121e linear yoke (first yoke)

121ea hole (first hole)

121eb hole (first hole)

121h linear yoke (second yoke)

121ha hole (second hole)

121hb hole (second hole)

220 OIS unit

220a cylindrical member (fixed member)

221 yoke (first yoke)

221a screw (first fastening member)

221b magnet

222 yoke (second yoke)

222a screw (second fastening member)

222b magnet

223 lens frame

320 BIS unit

321 yoke (first yoke)

321a screw (first fastening member)

322 yoke (second yoke)

322a screw (second fastening member)

352 imaging element (optical component)

352a holding frame

AX optical axis

C1 center axis

L1 to L6 lenses (optical components)

L21 lens (optical component)

1. An actuator for driving an optical component in a specific drive direction, the actuator comprising:
a first yoke that is disposed in the drive direction;
a second yoke that is disposed in the drive direction at a position opposite the first yoke;
a coil that is disposed at a position near the first yoke and the second yoke;
a first fastening member that fixes the first yoke to a fixed member; and
a second fastening member that fixes the second yoke to a fixed member;
wherein the first fastening member and the second fastening member are disposed at positions that are offset as viewed in an attachment direction of the first fastening member and the second fastening member.

2. The actuator according to claim 1,
wherein the first fastening member fixes the first yoke from a surface side of the first yoke that is opposite the second yoke, and
the second fastening member fixes the second yoke from a surface side of the second yoke that is opposite the first yoke.

3. The actuator according to claim 1,
wherein the first yoke has a first hole into which the first fastening member is inserted, and
the second yoke has a second hole into which the second fastening member is inserted.

4. The actuator according to claim 3,
wherein the first hole is provided at one location at a first end in a lengthwise direction of the first yoke and at two locations at a second end on an opposite side from the first end, and
the second hole is provided at two locations at a first end in the lengthwise direction of the second yoke and at one location at a second end on the opposite side from the first end.

5. The actuator according to claim 3,
wherein the first fastening member and the second fastening member have a head and a rotation shaft that are rotated by a tool, and rotate around the rotation shaft to screw into the first hole of the first yoke and the second hole of the second yoke, respectively.

6. The actuator according to claim 1,
wherein the heads of the first fastening member and the second fastening member are disposed between the first yoke and the second yoke.

7. The actuator according to claim 1,
wherein the first yoke and the second yoke are disposed along an optical axis direction of the optical component.

8. The actuator according to claim 7,
wherein the first fastening member and the second fastening member are disposed at positions that are offset in a circumferential direction centered on the optical axis of the optical component.

9. The actuator according to claim 1,
wherein the first yoke is disposed to an inside of the second yoke in a radial direction centered on an optical axis of the optical component,
the first fastening member fixes the first yoke from an outside in the radial direction, and
the second fastening member fixes the second yoke from the inside in the radial direction.

10. The actuator according to claim 1,
wherein the optical component includes a lens or an imaging element.

11. A lens barrel, comprising:
the actuator according to claim 1; and
a substantially cylindrical member that envelops the actuator.
